(19) United States
(12) Patent Application Publication
(10) Pub. No.: US 2012/0113066 A1
(43) Pub. Date: May 10, 2012

(54) OPTICAL PEN

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/975,253

(22) Filed: Dec. 21, 2010

(30) Foreign Application Priority Data
Nov. 4, 2010 (TW) 99138025

(51) Int. Cl. G09G 3/28

(52) U.S. Cl. 345/182

(57) ABSTRACT

The optical pen includes a transparent head, an optical source, an optical sensor, a first optical fiber module, a second bundled optical fiber, and a microcontroller. The first optical fiber module includes at least two first bundled optical fibers. Opposite ends of each first bundled optical fiber are respectively adjacent to the transparent head and the optical source. The first bundled optical fibers guide the light from the optical source to a reflective surface. The second bundled optical fiber is arranged between the first bundled optical fibers. The second bundled optical fiber guides the light reflected from the reflective surface to the optical sensor. The optical sensor converts the reflected light to electrical signals. The microcontroller processes the electrical signals to generate corresponding control signals and transmits the control signals to an external electronic device.

### BACKGROUND

1. Technical Field

The present disclosure relates to optical pens and, particularly, to an optical pen employing optical fibers.

2. Description of Related Art

A conventional optical pen employs optical lens or lenses to guide light from an optical source to a reflective surface, and employs optical lens or lenses to guide light reflected from the reflective surface to an optical sensor. The optical sensor converts the received reflected light to electrical signals. A microcontroller processes the electrical signals to generate corresponding control signals and transmits the control signals to an external electronic device, for example, a computer. The external electronic device is directed by the control signals to execute functions, for example, displaying a letter. With such configuration, the reflected light received by the optical sensor may not always be adequate, and thus the optical pens may not control the external electronic device to execute functions precisely.

### BRIEF DESCRIPTION OF THE DRAWINGS

The components of the drawings are not necessarily drawn to scale, the emphasis instead being placed upon clearly illustrating the principles of an optical pen. Moreover, in the drawings, like reference numerals designate corresponding parts throughout several views.

FIG. 1 is an isometric view of an optical pen in accordance with an exemplary embodiment.

FIG. 2 is a block diagram of the optical pen of FIG. 1 in accordance with an exemplary embodiment.

FIG. 3 is a schematic view of a first optical fiber module and a second bundled optical fiber of the optical pen of FIG. 2.

FIG. 4 is an isometric view illustrating the optical pen of FIG. 1 employed as a mouse in accordance with a first embodiment.

FIG. 5 is another isometric view illustrating the optical pen of FIG. 1 employed as a mouse in accordance with a second embodiment.

### DETAILED DESCRIPTION

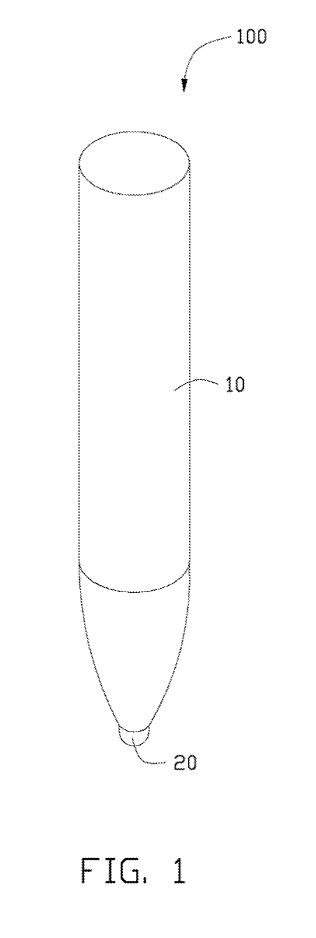

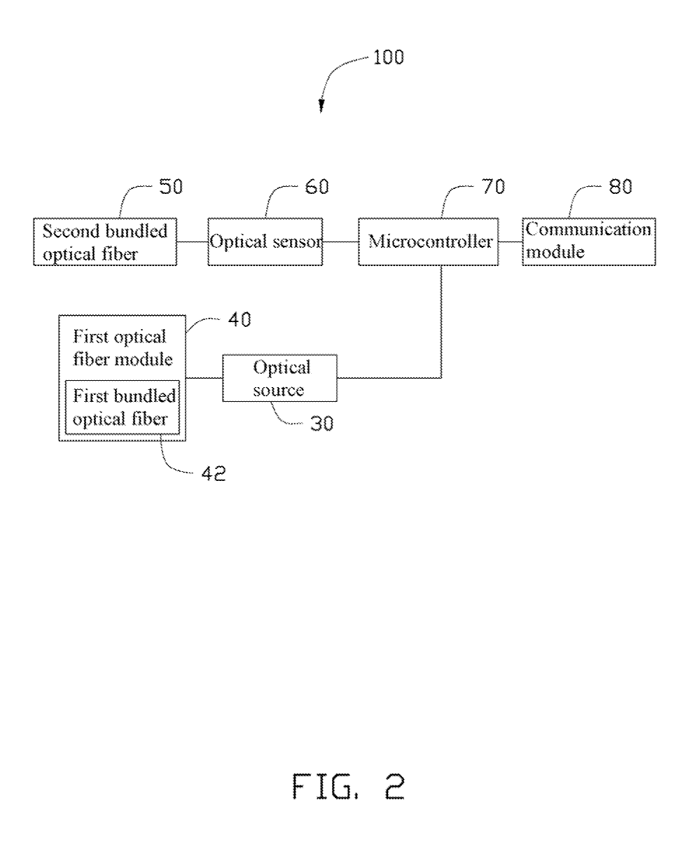

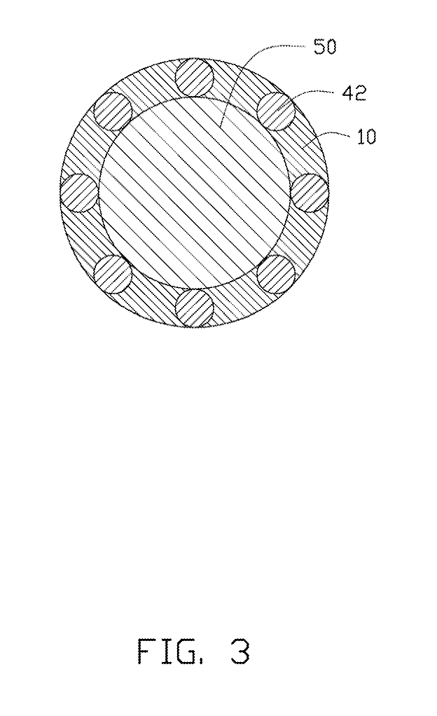

Referring to FIGS. 1-3, an embodiment of an optical pen 100 is illustrated. The optical pen 100 includes a main body 10, a head 20, an optical source 30, a first optical fiber module 40, a second bundled optical fiber 50, an optical sensor 60, a microcontroller 70, and a communication module 80. The main body 10 accommodates components of the optical pen 100. The head 20 is made of transparent material, such as transparent plastic, transparent glass, or the like. The optical source 30 may be a light-emitting diode (LED) or a laser. The optical sensor 60 may be a complementary metal oxide semiconductor (CMOS) or a charge-coupled device (CCD). The communication module 80 may include any one or more of a BLUETOOTH module, an infrared module, a USB interface, and a WIFI module, for example.

The first optical fiber module 40 is secured within the optical pen 100. In this embodiment, the first optical fiber module 40 includes at least two first bundled optical fibers 42. Opposite ends of each first bundled optical fiber 42 are respectively adjacent to the optical source 30 and the head 20. The first bundled optical fibers 42 guide the light emitted from the optical source 30 to a reflective surface (not shown).

The second bundled optical fiber 50 is secured within the main body 10 and arranged between the first bundled optical fibers 42. In this embodiment, the second bundled optical fiber 50 is arranged at the center of the first bundled optical fibers 42. One end of the second bundled optical fiber 50 is adjacent to the head 20, and an opposite end is attached to the optical sensor 60. The second bundled optical fiber 50 guides the light reflected from the reflective surface to the optical sensor 60.

The optical sensor 60 converts the received reflected light into electrical signals. The microcontroller 70 receives and processes the electrical signals to generate corresponding control signals, and transmits the control signals to an external electronic device communicating with the optical pen 100 through the communication module 80. The external electronic device is directed by the control signals to execute a predetermined function, displaying a letter for example.

In this embodiment, the optical pen 100 employs the first bundled optical fibers 42 to guide the light from the optical source 30 to the reflective surface, and employs the second bundled optical fiber 50 to guide the light reflected from the reflective surface to the optical sensor 60. By doing so, the light from the optical source 30 can be uniformly transmitted to the reflective surface, and the reflected light received by the optical sensor 60 is reliably adequate, thus the optical pen 100 can generate control signals to direct the external electronic device to execute functions precisely.

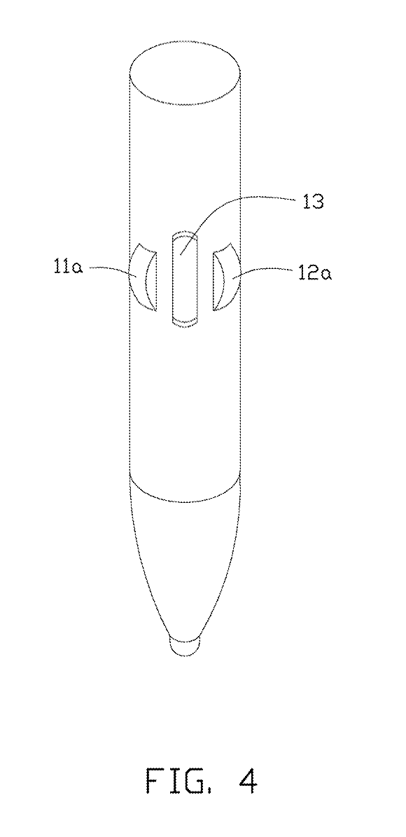

FIG. 4 shows the optical pen 100 employed as a mouse in a first embodiment. The optical pen 100 includes a first button 11a, a second button 12a, and a roller 13, all of which are electrically connected to the microcontroller 70 and are exposed outside the main body 10 for operation. The function of the first button 11a is similar to the function of a left button of a standard mouse, the function of the second button 12a is similar to the function of a right button of a standard mouse, and the function of the roller 13 is similar to the function of a roller of a standard mouse.

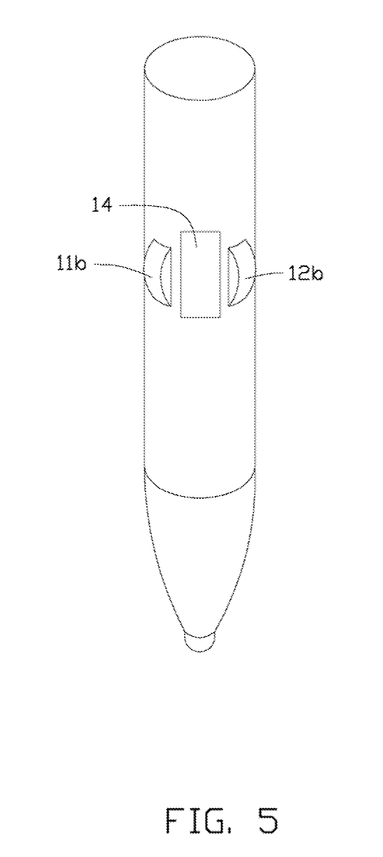

FIG. 5 shows the optical pen 100 employed as a mouse in a second embodiment. The optical pen 100 includes a first button 11b, a second button 12b, and a touch pad 14, all of which are electrically connected to the microcontroller 70 and are exposed outside the main body 10 for operation. The function of the first button l lb is similar to the function of a left button of a standard mouse, the function of the second button 12b is similar to the function of a right button of a standard mouse, and the function of the touch pad 14 is similar to the function of a roller of a standard mouse.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An optical pen comprising:
a transparent head;
a communication module;
an optical source;
an optical sensor;
a first optical fiber module comprising at least two first bundled optical fibers to guide the light from the optical source to a reflective surface;
a second bundled optical fiber arranged between the at least two first bundled optical fibers, an end of the second bundled optical fiber being adjacent to the transparent head, and an opposite end of the second bundled optical fiber being attached to the optical sensor, the second bundled optical fiber being operable to guide the light reflected from the reflective surface to the optical sensor, the optical sensor being configured to convert the received reflected light to electrical signals; and
a microcontroller to process the electrical signals from the optical sensor to generate corresponding control signals and transmit the control signals to an external electronic device communicating with the optical pen through the communication module.

2. The optical pen as described in claim 1, wherein the second bundled optical fiber is arranged at the center of the at least two first bundled optical fiber.

3. The optical pen as described in claim 1, wherein the optical source is a light-emitting diode.

4. The optical pen as described in claim 1, wherein the optical source is a laser.

5. The optical pen as described in claim 1, wherein the optical sensor is a complementary metal oxide semiconductor.

6. The optical pen as described in claim 1, wherein the optical sensor is a charge-coupled device.

7. The optical pen as described in claim 1, wherein the communication module comprises at least one module selected from the group consisting of a BLUETOOTH module, an infrared module, a USB interface, and a WIFI module.

8. The optical pen as described in claim 1, further comprising a first button and a second button connected to the microcontroller and exposed outside the optical pen for operation.

9. The optical pen as described in claim 8, further comprising a roller connected to the microcontroller and exposed outside the optical pen for operation.

10. The optical pen as described in claim 8, further comprising a touch pad connected to the microcontroller and exposed outside the optical pen for operation.
